(19) United States
(12) Patent Application Publication
(10) Pub. No.: US 2024/0346630 A1
(43) Pub. Date: Oct. 17, 2024

(54) IMAGE ACQUISITION FOR THREE-DIMENSIONAL (3D) COORDINATE MEASUREMENT DEVICES

(71) Applicant: FARO Technologies, Inc., Lake Mary, FL (US)

(72) Inventors: Daniel Döring, Ditzingen (DE); Rasmus Debitsch, Fellbach (DE)

(21) Appl. No.: 18/632,564

(22) Filed: Apr. 11, 2024

Related U.S. Application Data
(60) Provisional application No. 63/458,715, filed on Apr. 12, 2023.

(51) Int. Cl. G06T 5/73; G01S 17/42; G01S 17/86; G06T 3/4053; G06T 5/50

(52) U.S. Cl. CPC G06T 5/73; G01S 17/42; G01S 17/86; G06T 3/4053; G06T 5/50; G06T 2207/10024; G06T 2207/10028; G06T 2207/20084; G06T 2207/20201; G06T 2207/20212

(57) ABSTRACT

Examples described herein provide a computer-implemented method for sharpening an image acquired during movement of a three-dimensional (3D) coordinate measurement device. The method includes receiving the image from the 3D coordinate measurement device, wherein the image was acquired while the 3D coordinate measurement device was moving. The method further includes sharpening the image to generate a sharpened image based at least in part on at least one of movement information about the movement of the 3D coordinate measurement device or depth information. The method further includes performing, using the sharpened image, a scanning operation.

### CROSS-REFERENCE TO RELATED APPLICATIONS

This application claims the benefit of, and is a nonprovisional application of, U.S. Provisional Application Ser. No. 63/485,715, filed Apr. 12, 2023 entitled “IMAGE ACQUISITION FOR THREE-DIMENSIONAL (3D) COORDINATE MEASUREMENT DEVICES,” the contents of which is incorporated by reference herein.

### BACKGROUND

Embodiments described herein generally relate to measuring three-dimensional (3D) coordinates in an environment.

A 3D coordinate measurement device can be used to measure 3D coordinates of an object and/or environment. An example of a 3D coordinate measurement device is a time-of-flight (ToF) scanner, which is a scanner in which the distance to a target point is determined based on the speed of light in air of a beam of light traveling between the scanner and a target point. ToF scanners are typically used for scanning closed or open spaces such as interior areas of buildings, industrial installations, and tunnels. ToF scanners are used, for example, in industrial applications and accident reconstruction applications. A laser scanner optically scans and measures objects in a volume around the scanner through the acquisition of data points representing object surfaces within the volume. Such data points are obtained by transmitting a beam of light onto the objects and collecting the reflected or scattered light to determine the distance, two-angles (e.g., an azimuth and a zenith angle), and optionally a gray-scale value. The raw scan data is collected, stored, and sent to a processor or processors to generate a 3D image representing the scanned area or object. For the case in which the light source within a scanner is a laser, such a scanner is often referred to as a laser scanner. The term laser scanner is often also used for scanners that use light sources that are not lasers, such as light sources using superluminescent diodes for example.

ToF measuring systems such as those used in laser scanners can be one of two types: a phased-based ToF scanner or a pulsed ToF scanner. In a typical phase based ToF scanner, a beam of light is modulated at a plurality of frequencies before being launched to a target. After the modulated beam of light has completed a round trip to and from the target, it is demodulated to determine the returning phase of the each of the plurality of frequencies. A processor within the ToF scanner uses the demodulated frequencies and the speed of light in air to determine a distance from the scanner to the target. In contrast, a pulsed ToF scanner typically emits a short pulse of light and measures the elapsed time between launch of the pulse and return of the pulse after having completed a round trip to the target. A processor associated with the pulsed ToF scanner determines the distance from the scanner to the target based at based at least in part on the measured elapsed time and the speed of light in air. The ToF scanners used in laser scanners include a single optical detector that measures the signal returned from the target. Such optical detectors typically measure to frequencies of several hundred MHz or to pulse widths of a few picoseconds to nanoseconds.

More recently, ToF methods are being employed in camera sensors having a collection or array of photosensitive elements. Each of the photosensors in the array serves the same function as the single optical detector in a traditional ToF laser scanner, but the photosensors typically are more limited in the speed of their response and their optical bandwidths. On the other hand, arrays of photosensors are relatively inexpensive, thereby offering advantages where the range and accuracy requirements are not as stringent as for traditional laser scanners.

A device that uses an array of sensors to measure pulsed light is said to be a direct ToF (or dToF) device. A device that uses an array of sensors to measure light modulated at multiple frequencies is said to be an indirect ToF (or iToF) device. If an array of pixels using dToF or iToF is included within a camera having a camera lens, then both distances and angles to the target points are based on the signals received by the array of pixels.

While existing systems for measuring a distance to an object are suitable for their intended purposes the need for improvement remains, particularly in providing 3D measurement system having the features described herein.

### SUMMARY

In one embodiment, a computer-implemented method for sharpening an image acquired during movement of a three-dimensional (3D) coordinate measurement device is provided. The method includes receiving the image from the 3D coordinate measurement device, wherein the image was acquired while the 3D coordinate measurement device was moving. The method further includes sharpening the image to generate a sharpened image based at least in part on at least one of movement information about the movement of the 3D coordinate measurement device or depth information. The method further includes performing, using the sharpened image, a scanning operation.

In another embodiment, a computer-implemented method for generating a higher-resolution panoramic image from a plurality of lower-resolution images acquired during movement of a three-dimensional (3D) coordinate measurement device is provided. The method includes receiving the plurality of lower-resolution images from the 3D coordinate measurement device, wherein the image was acquired while the 3D coordinate measurement device was moving, wherein each of the plurality of lower-resolution images overlaps at least a portion of at least one other image of the plurality of images. The method further includes generating, based at least in part on movement information about the movement of the 3D coordinate measurement device, the higher-resolution panoramic image using the plurality of lower-resolution images from the 3D coordinate measurement device. The method further includes performing, using the higher-resolution panoramic, a scanning operation.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments described herein are apparent from the following detailed description taken in conjunction with the accompanying drawings in which:

FIG. 1 is a perspective view of a system for measuring 3D coordinates according to one or more embodiments described herein;

FIG. 2A is a schematic illustration of a dToF device for use with the system of FIG. 1 according to one or more embodiments described herein;

FIG. 2B is a schematic illustration of an iToF device for use with the system of FIG. 1 according to one or more embodiments described herein;

FIG. 3A is a schematic illustration of a first pattern used in measuring coordinates with the system of FIG. 1 according to one or more embodiments described herein;

FIG. 3B is a schematic illustration of a second pattern used in measuring coordinates with the system of FIG. 1 according to one or more embodiments described herein;

FIG. 3C is a schematic illustration of a third pattern used in measuring coordinates with the system of FIG. 1 according to one or more embodiments described herein;

FIG. 3D is a schematic illustration of a fourth pattern used in measuring coordinates with the system of FIG. 1 according to one or more embodiments described herein;

FIG. 3E is a schematic illustration of a fifth pattern that combines the third pattern and fourth pattern and is used in measuring coordinates with the system of FIG. 1 according to one or more embodiments described herein;

FIG. 4A depicts a block diagram of a front view of a 3D coordinate measurement device according to one or more embodiments described herein;

FIG. 4B depicts a block diagram of a side view of a 3D coordinate measurement device according to one or more embodiments described herein;

FIG. 5 depicts a flow diagram of a method for sharpening an image acquired during movement of a 3D coordinate measurement device according to one or more embodiments described herein;

FIG. 6 depicts a flow diagram of a method for generating a higher-resolution panoramic image from multiple lower-resolution single images acquired during movement of a 3D coordinate measurement device according to one or more embodiments described herein;

FIG. 7 depicts a higher-resolution panoramic image generated from multiple lower-resolution single images acquired during movement of a 3D coordinate measurement device according to one or more embodiments described herein; and

FIG. 8 depicts a block diagram of a processing system for implementing one or more embodiments described herein.

The diagrams depicted herein are illustrative. There can be many variations to the diagrams or the operations described therein without departing from the scope described herein. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

One or more embodiments described herein provide for image acquisition for 3D coordinate measurement devices. For example, one or more embodiments described herein provides for sharpening an image acquired during movement of a 3D coordinate measurement device. As another example, one or more embodiments described herein provides for generating a higher-resolution panoramic image from multiple lower-resolution single images acquired during movement of a 3D coordinate measurement device.

A 3D coordinate measurement device is any suitable device for measuring 3D coordinates or points in an environment or of an object, to generate data about the environment or object. A collection of 3D coordinate points is sometimes referred to as a point cloud. According to one or more embodiments described herein, a 3D coordinate measurement device can be a 3D laser scanner time-of-flight coordinate measurement device. It should be appreciated that while embodiments herein refer to a laser scanner, this is for example purposes and the claims should not be so limited. In other embodiments, other types of coordinate measurement devices or combinations of coordinate measurement devices are used, such as but not limited to triangulation scanners, structured light scanners, laser line probes, photogrammetry devices, light detection and ranging (LIDAR) devices, and the like. In some embodiments, the 3D coordinate measurement device can operate as an indirect ToF device. The 3D coordinate measurement device can additionally include one or more camera sensors for capturing images (e.g., of an environment or object).

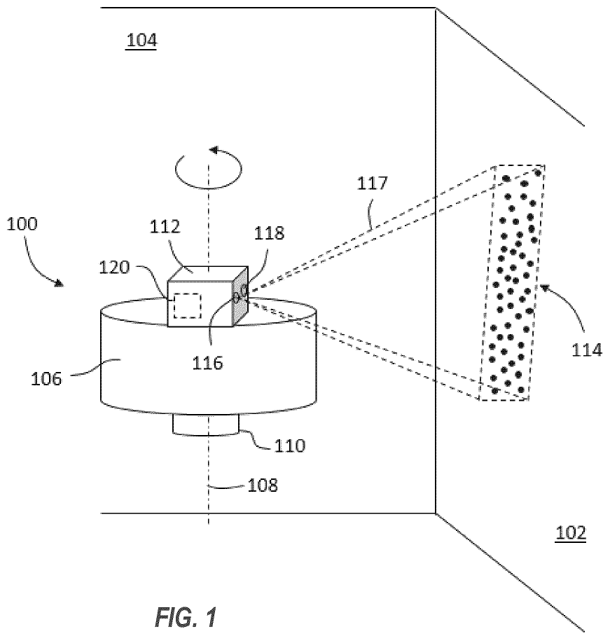

Referring now to FIG. 1, an embodiment of a system 100 is shown for measuring 3D coordinates on surfaces 102, 104 in an environment. The system 100 can be referred to as a 3D coordinate measurement device. The system 100 includes a body 106 that is configured to rotate about an axis 108. The body 106 is coupled to a suitable structure, such as a tripod for example. In an embodiment, the rotation or angular position of the body 106 is measured by a sensor 110, such as an angular encoder for example. The body 106 is coupled to, a suitable mechanism, such as a motor (not shown) that allows for the selective rotation of the body 106. In an embodiment, the body 106 is selectively rotated in incremental steps (e.g., a predetermined angular rotation) and paused for a predetermined amount of time. In still another embodiment, the body 106 is continuously rotated at a predetermined speed.

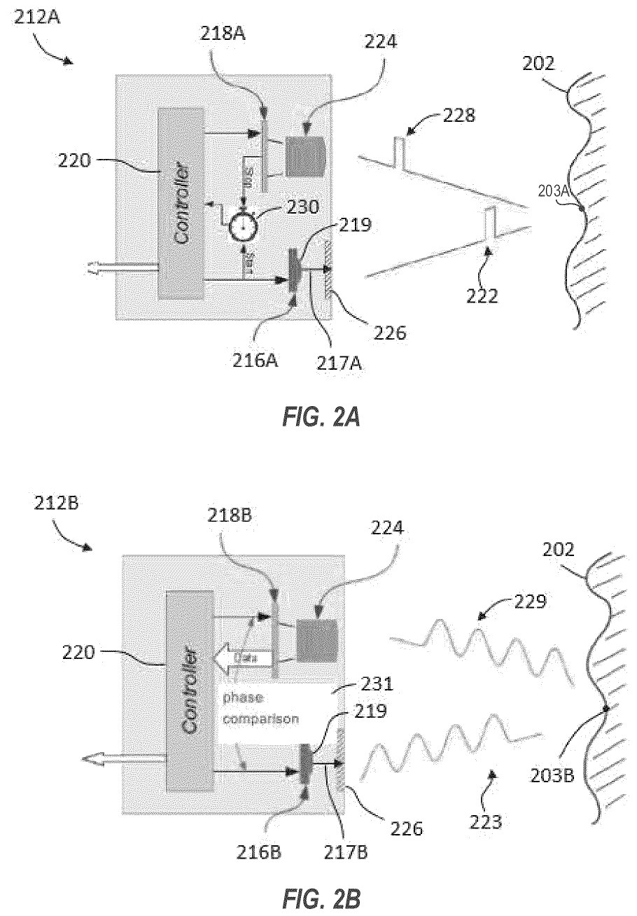

Coupled to the body 106 is a measurement device 112. In an embodiment, the measurement device 112 includes a light source 116 that emits a light beam 117 that includes a pattern of light 114 projected on the surfaces 102, 104 as the body is rotated about the axis 108. The pattern of light 114 reflects off of the surfaces 102, 104 and passes through a camera lens 118 before being received by a two-dimensional (2D) photosensitive array, as described in FIG. 2A and FIG. 2B. As discussed in more detail below, the measurement device 112 includes a controller 120 that is configured to determine the 3D coordinates of elements of the pattern 114 where the distance or depth is determined based at least in part on the speed of light in air using either time-based or phase-based time-of-flight methods.

Referring now to FIG. 2A, an embodiment is shown of dToF device 212A. A dToF device is a device that measures distances to points on a surface 202 by emitting a pulsed beam of light 222 that intersects the surface 202 at one or more points. At least a portion of the light intersecting the surface 202 reflects back to the dToF device 212A. In an embodiment, the dToF device 212A includes a light source 216A, such as a laser light source that emits a beam of light 217A at a predetermined wavelength for example. According to one or more embodiments described herein, a vertical-cavity surface-emitting laser (VCSEL) array is used, so the laser source itself emits multiple beams, and this set of beams goes through a diffractive optical element (DOE) for further processing. In an embodiment, the beam of light 217A from light source 216A passes through one or more optical elements 226, such as a diffractive optical element, a Powell lens, or a combination of the foregoing for example. One or more additional lens elements 219 is included in the optical path prior to launching of the beam of light 222. The optical elements 226 receive the beam of light 217A from light source 216A and generate one or more structured beams of light that form the pattern of light on the surface 202. The pattern of light includes elements that include dots, circles, ellipses, squares, polygons, and lines for example.

The light source 216A emits pulses of light 222 in response to signals from controller 220 (e.g., the controller 120). The pulses of light 222 strike the optical elements 226 to form a pulsed structured beam of light 222, which in turn leads to formation of a pattern of pulsed light on the surface 202. At least a portion of the light 228 is reflected back towards the device 212A. In an embodiment, the reflected light pulse 228 passes through an imaging lens 224 before passing to a 2D photosensitive array 218A. By knowing the location of a particular spot on the 2D photosensitive array 218A, an angular direction to a corresponding spot on the surface 202 can then be determined based on general properties of imaging lenses. In an embodiment, the 2D photosensitive array 218A includes more than 1000 pixels/channels. In other embodiments, the 2D photosensitive array is about 100,000 pixels/channels. The elapsed time for the light pulses 222 and 228 to complete a round trip from the one or more optical elements 226 to the imaging lens 224 is determined by a timer module 230 based at least in part on the elapsed time and the speed of light in air. It should be appreciated that in different embodiments, the timer module 230 is integral with the controller 220 or included in separate circuitry that transmits a signal to the controller 220. The 3D coordinates of the point 203A is determined based on the determined distance from the device 212A to a point on the surface 202 and on the angle from that point on the surface to the imaging lens 224.

It should be appreciated that while the example of FIG. 2A illustrates a single pulse 222, the light pattern emitted by the light source 216A and/or optical elements 226 represents a plurality of light pulses 222 that strike the surface 202 at different locations that each reflect back to the 2D photosensitive array 218A to generate the pattern of light on the surface 202. As such, each of these plurality of pulses 222 forms an element of the pattern for which a 3D coordinate is determined.

Referring now to FIG. 2B, an embodiment is shown of an iToF device 212B. The iToF device 212B measures distances to points on the surface 202. A portion of an emitted beam of light 223 intersects the surface 202 in one or more points that include the point 203B. The beam of light 223 is modulated at a plurality of frequencies before being launched to a target. After the modulated beam of light 223 has completed a round trip to and from the target, it is demodulated to determine the returning phase of the each of the plurality of frequencies. A processor (e.g., the controller 220) within the iToF device 212B uses the demodulated frequencies and the speed of light in air to determine a distance from the scanner to the target. In FIG. 2B, the iToF device 212B measures distances to the surface 202 by emitting a pulsed beam of light 223 that intersects the surface 202, at least a portion of which reflects back to the iToF device 212B. In an embodiment, the iToF device 212B includes a light source 216B, such as a laser light source that emits light at a predetermined wavelength and a predetermined phase for example. In an embodiment, the light source 216B emits two beams of light with different phases, such as 0 and 180 degrees or 90 and 270 degrees for example. In other embodiments, the light source 216B emits four beams of light, each with a different phase, such as 0, 90, 180 and 270 for example. In still other embodiments, the light source 216B sequentially emits beams of light with each of the sequential beams of light having a different phase.

In an embodiment, the light source 216B, emits a beam of light 217B at a predetermined wavelength for example. In an embodiment, the beam of light 217B passes through one or more optical elements 226, such as a diffractive optical element, a Powell lens, or a combination of the foregoing for example. One or more additional lens elements 219 are included in the optical path prior to launching of the beam of light 223. The optical elements 226 receive the beam of light 217B from light source 216B and generate one or more structured beams of light that form the pattern of light on the surface 202. The pattern of light includes elements such as dots, circles, ellipses, squares, polygons, and lines for example.

The light source 216B emits modulated light 223 in response to a signal from controller 220. The modulated light 223 strikes the optical elements 226 to form a modulated structured beam of light 223, which in turn leads to formation of a pattern of modulated light on the surface 202. At least a portion of the modulated light on the surface 202 is reflected back towards the device 212B. In an embodiment, the reflected modulated light passes through an imaging lens 224 before passing to a 2D photosensitive array 218B. The imaging lens 224 causes rays of light emerging from a particular point on the surface 202 to be focused onto a particular spot on the photosensitive array 218B. Hence, by knowing the location of the particular spot on the photosensitive array 218B, an angular direction to a corresponding spot on the surface 202 can be determined. In an embodiment, the 2D array 218A includes more than 1000 pixels/channels. In other embodiments, the 2D array is about 100,000 pixels/channels.

The reflected light 229 is received by pixels/channels on a 2D photosensitive array 218B. In an embodiment, the 2D array 218B includes more than 1000 pixels/channels. In other embodiments, the 2D array is about 100,000 pixels/channels. In an embodiment, the light pulse 229 passes through an imaging lens 224 before being received by the 2D photosensitive array 218B.

In the embodiment using the iToF 212B, the distance is determined by a comparison module 231, which compares the phases of one or more modulated frequencies of the received beam to the phases of the one or more modulated frequencies of the emitted light beam. In an embodiment, phases of two light beams are compared (e.g. having phases 0 and 180 degrees). In another embodiment, phases of at least four light beams are compared (e.g. having phases of 0, 90, 180 and 270 degrees). In an embodiment, the 2D array acquires two images per frame, with each image being based on reflected light 229 having a different phase. In an embodiment, the 2D array is found on a Model IMX 556 or Model IMX 570 manufactured by Sony Corporation.

Once the position and rotation coordinates of the device 212B (e.g. the rotational angle about the axis 108) are determined, the three-dimensional coordinates of the point where the light pulse 223 intersects the surface 202 is determined.

In other embodiments, the iToF 212A, 212B is a frequency modulated continuous-wave (FMCW) LIDAR array. In this embodiment, the light source and photosensitive array are combined into a single device where each pixel/channel acts as a light source. As such, as used herein, the term light source includes a light source integrated into the photosensitive array.

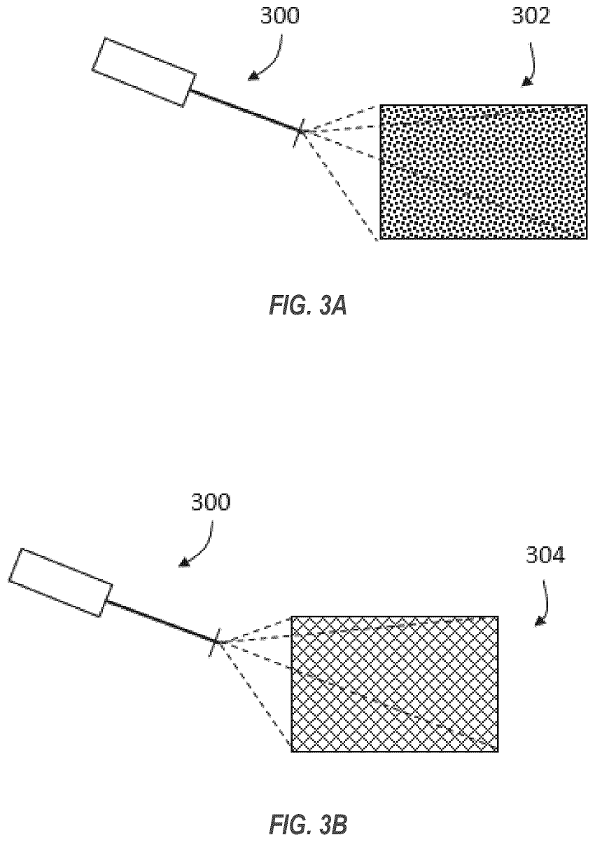

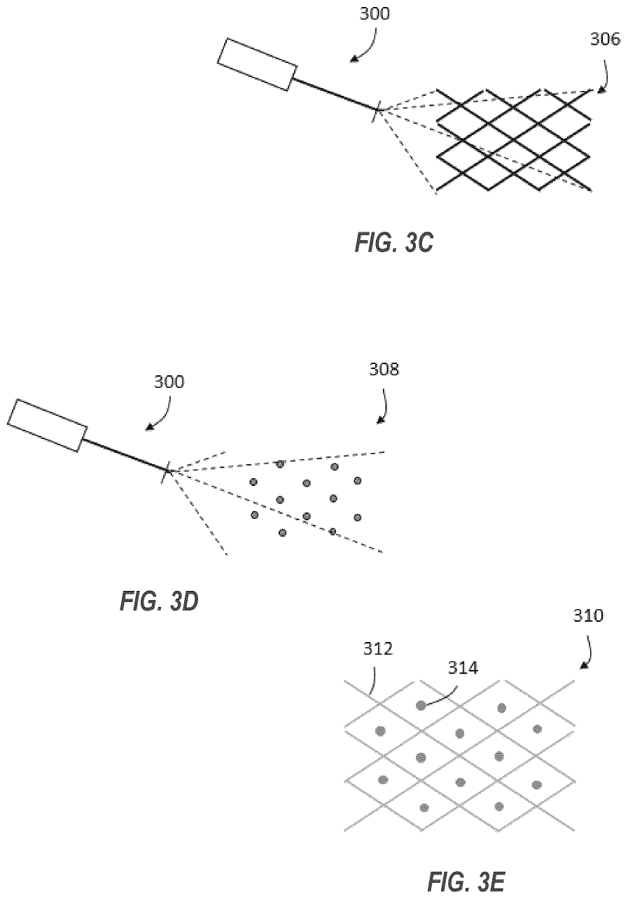

It should be appreciated that different types of patterns are used to generate a dense point cloud. As an example, a homogeneous light distribution can be used in combination with a dot or line pattern. Referring to FIGS. 3A-3E, examples are shown of different patterns 302, 304, 306, 308, 310. The patterns 302, 304, 306, 308, 310 are generated by a 3D coordinate measurement device 300 (e.g., the system 100) using optical elements, such as a diffractive optical element or Powell lens, for example. In the embodiment of FIG. 3A, a pattern, such as a dense random dot pattern 302, is projected by the light source of the 3D coordinate measurement device 300. In the embodiment of FIG. 3B, a pattern such as a dense plurality of crossed lines 304 are projected by the light source of the 3D coordinate measurement device 300. In the embodiment of FIG. 3C, a pattern such a broadly spaced crossing line pattern 306 are projected by the light source of the 3D coordinate measurement device 300. In the embodiment of FIG. 3D, a pattern such as a dot pattern 308 is projected by the light source of the 3D coordinate measurement device 300. The embodiment of FIG. 3E illustrates a pattern that combines and superimposes pattern 306 and pattern 308 to generate a pattern 310 that includes both dots and crossed lines. It should be appreciated that other combinations of patterns are also possible in other embodiments.

In some embodiments, the elements of the pattern of light has different optical brightness levels. For example, as shown in FIG. 3E, the optical power emitted to generate the lines 312 are higher than the optical power emitted to generate the dots 314. In an embodiment, the pattern of light includes a first plurality of elements and a second plurality of elements, where the first optical power of the light used to generate the first plurality of elements is larger than the second optical power of the light used to generate the second plurality of elements. In an embodiment, the first optical power is 1.5 times the second optical power, although other values of differences of power between the first optical power and the second optical power are possible.

It is known in the art to emit a pulse of light 222 that continuously covers a portion of a surface 202 before capturing the reflected light with a photosensitive array 218A of a dToF device or a photosensitive array 218B of an iToF device. A disadvantage of such an approach is that the power available to illuminate the area captured by each pixel of the photosensitive array 218A or 218B is limited, which reduces performance of such a dToF or iToF system. Reduced performance comes in the form of reduced accuracy, slower measurements, reduced maximum distances, or reduced ability to measure dark objects. By concentrating the emitted light into a reduced number of elements of a structured light pattern, each of the elements has a greater optical power, thereby improving performance. In particular, in many cases, it is preferable to obtain a relatively sparse collection of points at higher accuracy, longer distances, and higher data capture rates.

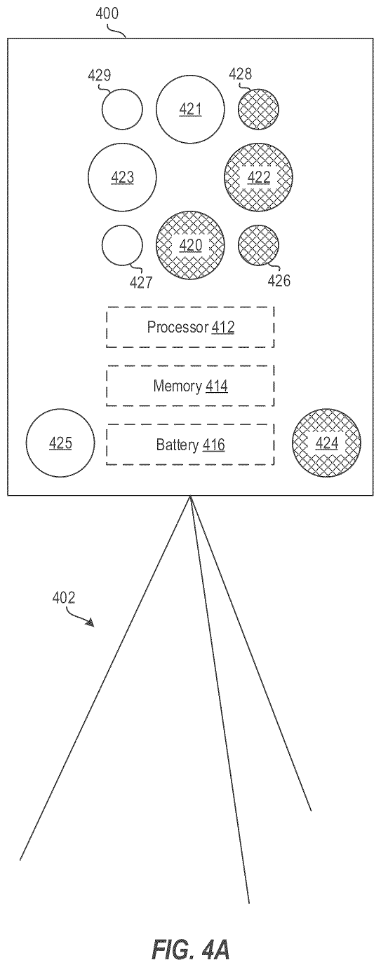

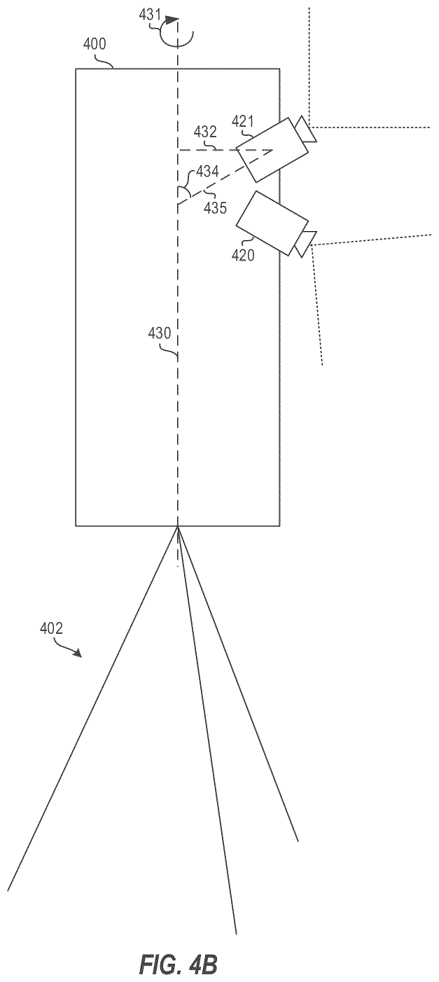

Referring now to FIGS. 4A and 4B, an embodiment is shown of a 3D coordinate measurement device 400 (e.g., the system 100) for measuring 3D coordinates of surfaces in the environment. The 3D coordinate measurement device 400 includes a stand or tripod 402 connectable to a housing of the 3D coordinate measurement device 400, which causes the 3D coordinate measurement device 400 to be a predetermined distance off a horizontal surface, such as the floor of an environment.

In the example of FIGS. 4A and 4B, the 3D coordinate measurement device 400 includes a processor 412, a memory 414, and a battery 416 to provide power to components of the 3D coordinate measurement device 400. The various features and functionality described regarding FIGS. 4A and 4B can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the features and functionality described herein can be a combination of hardware and programming. The programming can be processor executable instructions stored on a tangible memory, and the hardware can include the processing device 412 for executing those instructions. Thus a system memory (e.g., memory 414) can store program instructions that when executed by the processing device 412 implement the features and functionality described herein, such as image acquisition.

The 3D coordinate measurement device 400 further includes multiple sensors and light sources for collecting 3D coordinates about an environment or object. Examples of such sensors and light sources include color camera sensors 420, 421; iToF camera sensors 422, 423, 424, 425; and laser projectors 426, 427, 428, 429.

The 3D coordinate measurement device 400 is configured to rotate about an axis 430 as shown in FIG. 4B relative to the tripod 402. The body 406 is rotated by a suitable device, such as a motor (not shown) mounted within the 3D coordinate measurement device 400 or disposed between the 3D coordinate measurement device 400 and the tripod 402. It should be appreciated that as the 3D coordinate measurement device 400 rotates during operation about the axis 430, the field of view of the sensors (e.g., the color camera sensors 420, 421; the iToF camera sensors 422, 423, 424, 425; and the laser projectors 426, 427, 428, 429) rotates about the axis 430 as well. Conventionally, for best color quality image acquisition, 3D coordinate measurement devices stopped rotating to record each color image from a fixed pose. However, stopping the movement of the 3D coordinate measurement device to capture color images slows down the scan process.

According to one or more embodiments described herein, a first subset of the sensors can be configured to collect 3D coordinate data about a first region (e.g., a lower scan half) and a second subset of the sensors can be configured to collect 3D coordinate data about a second region (e.g., an upper scan half). For example, the first subset can include the sensors shown with crosshatching in FIGS. 4A and 4B, namely the color camera sensor 420; the iToF camera sensors 422, 424; and the laser projectors 426, 428. The second subset can include the sensors shown without crosshatching in FIGS. 4A and 4B, namely the color camera sensor 421; the iToF camera sensors 422, 425; and the laser projectors 427, 429.

One or more embodiments described herein provide for generating high quality color images using the 3D coordinate measurement device 400 while the 3D coordinate measurement device 400 rotates about the axis 430. One challenge of generating high quality color detail with a laser scanner is that the recording of color images at fixed positions takes up a considerable amount of the scan time. For a device that records scans fast, this problem is even more pronounced.

One or more embodiments described herein address this challenge by removing motion-induced blurring within images that were captured while the image capturing device (e.g., the color camera sensors 420, 421) was moving (e.g., while the 3D coordinate measurement device 400 rotates about the axis 430). For example, machine learning deconvolution techniques and/or neural networks can be used to remove motion-induced blurring within images as described herein.

Another challenge is that material cost of camera sensors can be significant relative to the overall cost of the scanner system, and it is desirable to reduce this cost. The use of high-resolution camera sensors to capture high quality images only increases the cost of the scanner system and is therefore undesirable. However, using lower cost (and thus lower quality) camera sensors conventionally does not provide high quality color images while the 3D coordinate measurement device 400 is scanning (e.g., rotating about the axis 430).

One or more embodiments described herein address this challenge by capturing and combining multiple low-resolution images to generate a high-resolution panoramic images. For example, video super-resolution techniques can be used to generate a high-quality panoramic image using images that were captured while the image capturing device (e.g., the color camera sensors 420, 421) was moving (e.g., while the 3D coordinate measurement device 400 rotates about the axis 430).

Particularly, one or more embodiments described herein provide for fast and low-cost color image acquisition using a 3D coordinate measurement device, such as a laser scanner or other suitable ToF device. According to one or more embodiments described herein, the 3D coordinate measurement device 400 can operate while affixed to the tripod 402 as shown in FIGS. 4A and 4B with a defined rotation about the axis 430. According to one or more embodiments described herein, the 3D coordinate measurement device 400 can operate in a free-hand scanning mode where the 3D coordinate measurement device 400 is moved by hand, such as by a user. According to one or more embodiments described herein, the 3D coordinate measurement device 400 can be affixed to another structure, device, surface, and/or the like including combinations and/or multiples thereof.

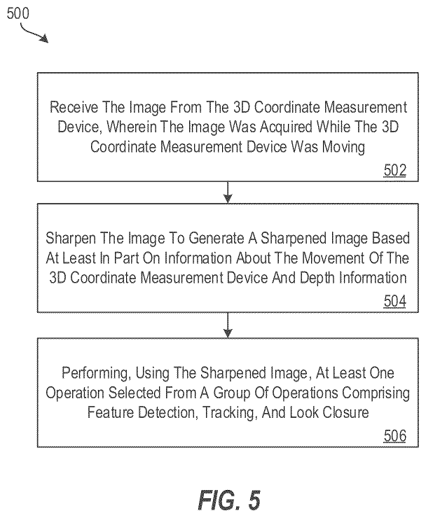

FIGS. 4A and 4B are now described with further reference to FIGS. 5 and/or 6.

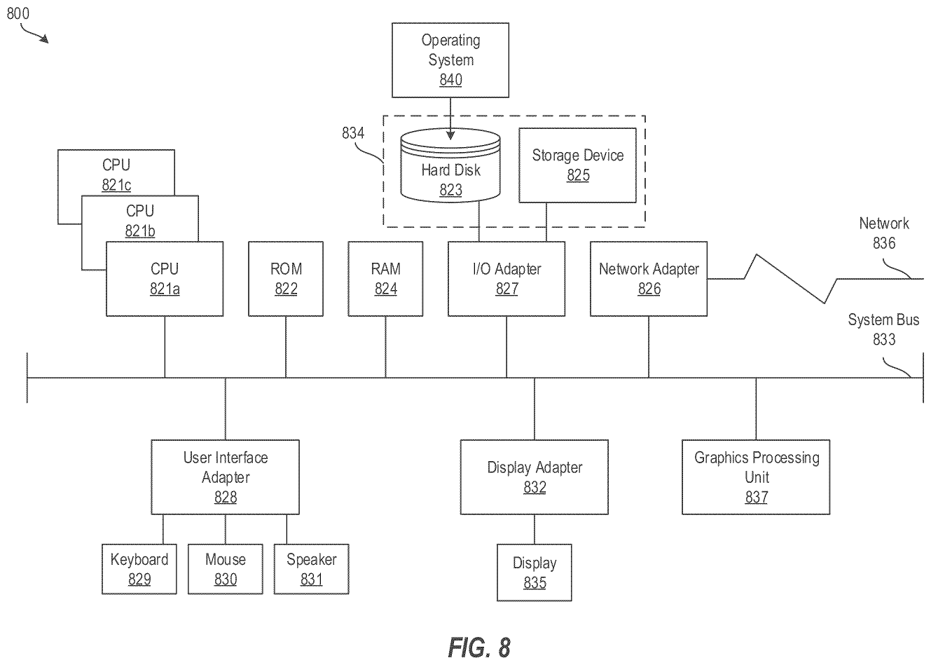

Particularly, FIG. 5 depicts a flow diagram of a method 500 for sharpening images acquired during movement of a 3D coordinate measurement device according to one or more embodiments described herein. The method 500 can be performed using any suitable system, device, and/or processing resource, such as the controller 100 of FIG. 1, the processing device 402 of FIG. 4A, the processing system 800 of FIG. 8, and/or the like including combinations and/or multiples thereof, but is not so limited.

At block 502, a processing resource (e.g., the processing device 412 of FIG. 4A, the processing system 800 of FIG. 8) receives an image from a 3D coordinate measurement device (e.g., the 3D coordinate measurement device 400 of FIGS. 4A and 4B). For example, the 3D coordinate measurement device 400 acquires the image using one or more of the color camera sensors 420, 421. The images can be acquired while the 3D coordinate measurement device 400 was moving (e.g., rotating about an axis of rotation, lateral movement relative to an environment, and/or the like including combinations and/or multiples thereof).

At block 504, the processing resource sharpens the image to generate a sharpened image. According to one or more embodiments described herein, sharpening the image is performed by applying machine learning to the image. Machine learning is a type of artificial intelligence (AI) that incorporates and utilizes rule-based decision making and AI reasoning to accomplish the various operations described herein. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” and/or “trained machine learning model”) can be used for sharpening images, for example. In one or more embodiments, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same or similar techniques can be applied in the case of sharpening images as described herein.

One approach to sharpening images using machine learning is to use neural network based algorithms to sharpen the image. For example, conditional generative adversarial networks and a multi-component loss function approach can be used to sharpen images by deblurring images, as described in “DeblurGAN: Blind Motion Deblurring Using Conditional Adversarial Networks” by Orest Kupyn et al., which is incorporated herein in its entirety. Another approach for sharpening images is to use deconvolution. Deconvolution is a mathematical technique used to reverse or reduce certain effects in images, such as blurring, noise, scatter, glare, and/or the like including combinations and/or multiples thereof.

According to one or more embodiments described herein, a trained model for sharpening (e.g., deblurring) images can use movement information about the movement of the 3D coordinate measurement device as input, along with the image. Examples of movement information are now described with respect to FIG. 4B. One example of movement information is a rotational velocity of the rotation of the 3D coordinate measurement device 400 about the axis 430, shown by the arrow 431. Another example of movement information is the angle of the orientation of the axis 430 with respect to gravity. Another example of movement information is a distance 432 of an entrance pupil (not shown) of a color camera sensor (e.g., the color camera sensor 420) of the 3D coordinate measurement device 400 to the axis 430. Yet another example of movement information is an angle 434 between the optical axis 435 of the color camera sensor (e.g., the color camera sensor 420) of the 3D coordinate measurement device 430 and the axis 430. Another example of movement information is lateral movement or vertical movement (e.g., movement of the 3D coordinate measurement device 400 within an environment, such as from a first location to a second location).

According to one or more embodiments described herein, the trained model for sharpening (e.g., deblurring) images can use depth information. Depth information can be measured (e.g., based at least in part on the speed of light in air using either time-based or phase-based time-of-flight methods) and/or estimated (e.g., using photogrammetry).

Photogrammetry is a technique for measuring objects using images, such as photographic images acquired by a digital camera for example. Photogrammetry can make 3D measurements from 2D images or photographs. When two or more images are acquired at different positions that have an overlapping field of view, common points or features are identified on each image. By projecting a ray from the camera location to the feature/point on the object, the 3D coordinate of the feature/point is determined using trigonometry or triangulation. In some examples, photogrammetry is based on markers/targets (e.g., lights or reflective stickers) or based on natural features. To perform photogrammetry, for example, images are captured, such as with a camera sensor (e.g., the color camera sensors 420, 421), such as a photosensitive array for example. By acquiring multiple images of an object, or a portion of the object, from different positions or orientations, 3D coordinates of points on the object are determined based on common features or points and information on the position and orientation of the camera when each image was acquired. In order to obtain the desired information for determining 3D coordinates, the features are identified in two or more images. Since the images are acquired from different positions or orientations, the common features are located in overlapping areas of the field of view of the images. It should be appreciated that photogrammetry techniques are described in commonly-owned U.S. Pat. No. 10,782,188, the contents of which are incorporated by reference herein. With photogrammetry, two or more images are captured and used to determine 3D coordinates of features.

At block 506, the sharpened image can be used to perform a scanning operation. For example, the scanning operation can be feature detection, tracking, and/or loop closure. Feature detection involves detecting a feature, such as a geometric primitive (e.g., a point, line, curve, planar surface, curved surface, volumetric solid, and/or the like including combinations and/or multiples thereof). Tracking involves determining a position and/or an orientation of a device, such as the 3D coordinate measurement device 400, within an environment. Loop closure involves detecting when the 3D coordinate measurement device 400, moving within an environment, has returned to a previously scanned region and using that information to reduce uncertainty in mapping (e.g., to reduce error between an estimated pose and a real pose).

Additional processes are also included, and it should be understood that the process depicted in FIG. 5 represents an illustration, and that other processes are added or existing processes are removed, modified, or rearranged without departing from the scope of the present disclosure.

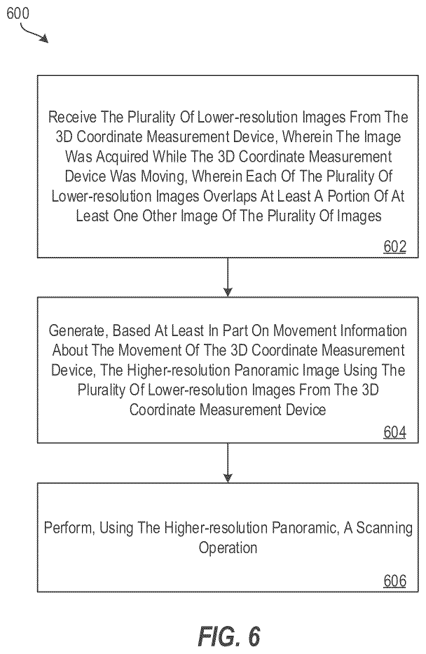

FIG. 6 depicts a flow diagram of a method 600 for generating a higher-resolution panoramic image from multiple lower-resolution single images acquired during movement of a 3D coordinate measurement device according to one or more embodiments described herein. The method 600 can be performed using any suitable system, device, and/or processing resource, such as the controller 100 of FIG. 1, the processing device 402 of FIG. 4A, the processing system 800 of FIG. 8, and/or the like including combinations and/or multiples thereof, but is not so limited. It should be appreciated that the lower-resolution image(s) have a relatively lower-resolution than the higher-resolution panoramic image.

At block 602, the processing resource (e.g., the processing device 412 of FIG. 4A, the processing system 800 of FIG. 8) receives a plurality of lower-resolution images from a 3D coordinate measurement device (e.g., the 3D coordinate measurement device 400 of FIGS. 4A and 4B). For example, the 3D coordinate measurement device 400 acquires the plurality of lower-resolution images using one or more of the color camera sensors 420, 421. Each of the plurality of lower-resolution images overlaps at least a portion of at least one other image of the plurality of lower-resolution images. The images can be acquired while the 3D coordinate measurement device 400 was moving (e.g., rotating about an axis of rotation, lateral movement relative to an environment, and/or the like including combinations and/or multiples thereof).

At block 604, the processing resource generates, based at least in part on movement information about the movement of the 3D coordinate measurement device, the higher-resolution panoramic image using the plurality of lower-resolution images from the 3D coordinate measurement device. Examples of movement information are now described with respect to FIG. 4B. One example of movement information is a rotational velocity of the rotation of the 3D coordinate measurement device 400 about the axis 430, shown by the arrow 431. Another example of movement information is the angle of the orientation of the axis 430 with respect to gravity. Another example of movement information is a distance 432 of an entrance pupil (not shown) of a color camera sensor (e.g., the color camera sensor 420) of the 3D coordinate measurement device 400 to the axis 430. Yet another example of movement information is an angle 434 between the optical axis 435 of the color camera sensor (e.g., the color camera sensor 420) of the 3D coordinate measurement device 430 and the axis 430.

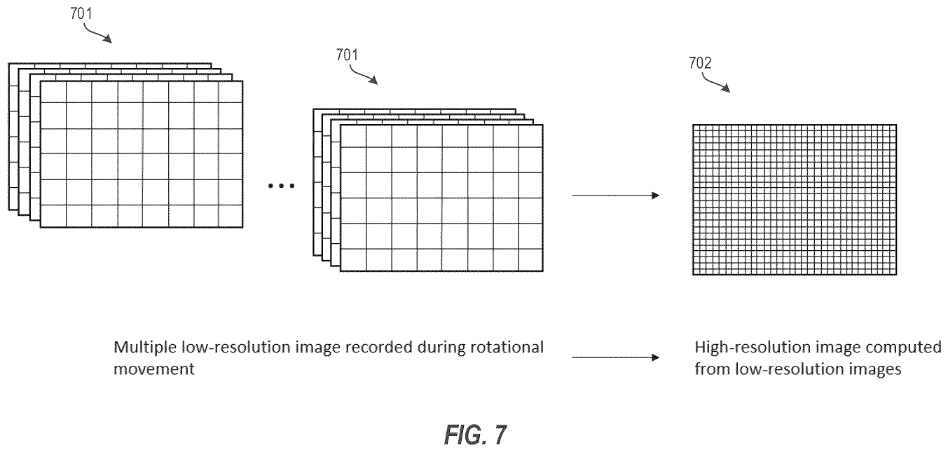

Referring now to FIG. 7, a higher-resolution panoramic image 702 is shown. The higher-resolution panoramic image 702 is generated from multiple lower-resolution single images 701 acquired during movement of a 3D coordinate measurement device according to one or more embodiments described herein

With continued reference to FIG. 6, at block 606, the higher-resolution panoramic image can be used to perform a scanning operation. For example, the scanning operation can be feature detection, tracking, and/or loop closure. Feature detection involves detecting a feature, such as a geometric primitive (e.g., a point, line, curve, planar surface, curved surface, volumetric solid, and/or the like including combinations and/or multiples thereof). Tracking involves determining a position and/or an orientation of a device, such as the 3D coordinate measurement device 400, within an environment. Loop closure involves detecting when the 3D coordinate measurement device 400, moving within an environment, has returned to a previously scanned region and using that information to reduce uncertainty in mapping (e.g., to reduce error between an estimated pose and a real pose).

According to an embodiment, the higher-resolution panoramic image can be displayed on a display (e.g., the display 835 of FIG. 8). As an example, the display can be a display of a smartphone, laptop, or other similar user computing device. As another example, the display can be integrated into or associated with the 3D coordinate measurement device 400.

Additional processes are also included, and it should be understood that the process depicted in FIG. 6 represents an illustration, and that other processes are added or existing processes are removed, modified, or rearranged without departing from the scope of the present disclosure.

Example embodiments of the disclosure include or yield various technical features, technical effects, and/or improvements to technology. Example embodiments of the disclosure provide embodiments for image acquisition for 3D coordinate measurement devices. These aspects of the disclosure constitute technical features that yield the technical effect of sharpening images that are blurry due to being captured by a 3D coordinate measurement device while the 3D coordinate measurement device was rotating about an axis of rotation. Accordingly, the 3D coordinate measurement device is improved because it is capable of improving image quality of captured images. Further aspects of the disclosure constitute technical features that yield the technical effect of generating a higher-resolution panoramic image from multiple lower-resolution images. Accordingly, the 3D coordinate measurement device is improved because it is capable of generating a higher-resolution panoramic image without having a higher-resolution panoramic camera sensor. That is, the 3D coordinate measurement device is enabled to use lower-resolution color camera sensors to generate a higher-resolution panoramic image. As a result of these technical features and technical effects, a 3D coordinate measurement device in accordance with example embodiments of the disclosure represents an improvement to existing 3D coordinate measurement devices. It should be appreciated that the above examples of technical features, technical effects, and improvements to technology of example embodiments of the disclosure are merely illustrative and not exhaustive.

It is understood that one or more embodiments described herein is capable of being implemented in conjunction with any other type of computing environment now known or later developed. For example, FIG. 8 depicts a block diagram of a processing system 800 for implementing the techniques described herein. In examples, processing system 800 has one or more central processing units (“processors” or “processing resources” or “processing devices”) 821a, 821b, 821c, etc. (collectively or generically referred to as processor(s) 821 and/or as processing device(s)). In aspects of the present disclosure, each processor 821 can include a reduced instruction set computer (RISC) microprocessor. Processors 821 are coupled to system memory (e.g., random access memory (RAM) 824) and various other components via a system bus 833. Read only memory (ROM) 822 is coupled to system bus 833 and include a basic input/output system (BIOS), which controls certain basic functions of processing system 800.

Further depicted are an input/output (I/O) adapter 827 and a network adapter 826 coupled to system bus 833. I/O adapter 827 is a small computer system interface (SCSI) adapter that communicates with a hard disk 823 and/or a storage device 825 or any other similar component. I/O adapter 827, hard disk 823, and storage device 825 are collectively referred to herein as mass storage 834. Operating system 840 for execution on processing system 800 is stored in mass storage 834. The network adapter 826 interconnects system bus 833 with an outside network 836 enabling processing system 800 to communicate with other such systems.

A display 835 (e.g., a display monitor) is connected to system bus 833 by display adapter 832, which includes a graphics adapter to improve the performance of graphics intensive applications and a video controller. In one aspect of the present disclosure, adapters 826, 827, and/or 832 are connected to one or more I/O busses that are connected to system bus 833 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 833 via user interface adapter 828 and display adapter 832. A keyboard 829, mouse 830, and speaker 831 is interconnected to system bus 833 via user interface adapter 828, which include, for example, a Super I/O chip integrating multiple device adapters into a single integrated circuit.

In some aspects of the present disclosure, processing system 800 includes a graphics processing unit 837. Graphics processing unit 837 is a specialized electronic circuit designed to manipulate and alter memory to accelerate the creation of images in a frame buffer intended for output to a display. In general, graphics processing unit 837 is very efficient at manipulating computer graphics and image processing, and has a highly parallel structure that makes it more effective than general-purpose CPUs for algorithms where processing of large blocks of data is done in parallel.

Thus, as configured herein, processing system 800 includes processing capability in the form of processors 821, storage capability including system memory (e.g., RAM 824), and mass storage 834, input means such as keyboard 829 and mouse 830, and output capability including speaker 831 and display 835. In some aspects of the present disclosure, a portion of system memory (e.g., RAM 824) and mass storage 834 collectively store the operating system 840 to coordinate the functions of the various components shown in processing system 800.

In addition to one or more of the features described herein, or as an alternative, further embodiments of the method include receiving the image from the 3D coordinate measurement device includes acquiring, by the 3D coordinate measurement device, the image.

In addition to one or more of the features described herein, or as an alternative, further embodiments of the method include that the image is acquired using a color camera sensor.

In addition to one or more of the features described herein, or as an alternative, further embodiments of the method including that the movement information includes rotational velocity of a rotation of the 3D coordinate measurement device about an axis of rotation.

In addition to one or more of the features described herein, or as an alternative, further embodiments of the method including that the movement information includes an angle of an orientation of an axis of rotation relative to gravity.

In addition to one or more of the features described herein, or as an alternative, further embodiments of the method including that the movement information includes a distance of an entrance pupil of a color camera sensor of the 3D coordinate measurement device to an axis of rotation.

In addition to one or more of the features described herein, or as an alternative, further embodiments of the method including that the movement information includes an angle between an optical axis of a color camera sensor of the 3D coordinate measurement device and an axis of rotation.

In addition to one or more of the features described herein, or as an alternative, further embodiments of the method include that the depth information is measured based at least in part on a speed of light in air using a time-of-flight method.

In addition to one or more of the features described herein, or as an alternative, further embodiments of the method include that the depth information is estimated using photogrammetry.

In addition to one or more of the features described herein, or as an alternative, further embodiments of the method include that the operation is selected from a group including feature detection, tracking, and loop closure.

In addition to one or more of the features described herein, or as an alternative, further embodiments of the method include that the moving includes the 3D coordinate measurement device rotating about an axis of rotation.

In addition to one or more of the features described herein, or as an alternative, further embodiments of the method include that the sharpening includes applying machine learning to the image.

In addition to one or more of the features described herein, or as an alternative, further embodiments of the method include that the sharpening also includes applying deconvolution to the image.

In addition to one or more of the features described herein, or as an alternative, further embodiments of the method include displaying, on a display, the sharpened image.

In addition to one or more of the features described herein, or as an alternative, further embodiments of the method include receiving the plurality of lower-resolution images from the 3D coordinate measurement device including acquiring, by the 3D coordinate measurement device, the plurality of lower-resolution images.

In addition to one or more of the features described herein, or as an alternative, further embodiments of the method include that the plurality of lower-resolution images are acquired using a color camera sensor.

In addition to one or more of the features described herein, or as an alternative, further embodiments of the method including the movement information includes rotational velocity of a rotation of the 3D coordinate measurement device about an axis of rotation.

In addition to one or more of the features described herein, or as an alternative, further embodiments of the method including the movement information includes an angle of an orientation of an axis of rotation relative to gravity.

In addition to one or more of the features described herein, or as an alternative, further embodiments of the method including the movement information includes a distance of an entrance pupil of a color camera sensor of the 3D coordinate measurement device to an axis of rotation.

In addition to one or more of the features described herein, or as an alternative, further embodiments of the method including the movement information includes an angle between an optical axis of a color camera sensor of the 3D coordinate measurement device and an axis of rotation.

In addition to one or more of the features described herein, or as an alternative, further embodiments of the method include the operation is selected from a group including feature detection, tracking, and loop closure.

In addition to one or more of the features described herein, or as an alternative, further embodiments of the method include displaying, on a display, the higher-resolution panoramic image. The flow diagram(s) and block diagram(s) in the Figures illustrate the architecture, functionality, and operation of possible implementations of systems, methods, and computer program products according to various embodiments described herein. In this regard, each block in the flow diagram(s) or block diagram(s) represent a module, segment, or portion of instructions, which includes one or more executable instructions for implementing the specified logical function(s). In some alternative implementations, the functions noted in the blocks occur out of the order noted in the Figures. For example, two blocks shown in succession be executed substantially concurrently, or the blocks are sometimes executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments described herein have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to explain the principles of the embodiments, the practical application or technical improvement over technologies found in the marketplace, or to enable others of ordinary skill in the art to understand the embodiments described herein.

What is claimed is:

1. A computer-implemented method for sharpening an image acquired during movement of a three-dimensional (3D) coordinate measurement device, the method comprising:
receiving the image from the 3D coordinate measurement device, wherein the image was acquired while the 3D coordinate measurement device was moving;
sharpening the image to generate a sharpened image based at least in part on at least one of movement information about the movement of the 3D coordinate measurement device or depth information; and
performing, using the sharpened image, a scanning operation.

2. The computer-implemented method of claim 1, wherein receiving the image from the 3D coordinate measurement device comprises acquiring, by the 3D coordinate measurement device, the image.

3. The computer-implemented method of claim 2, wherein the image is acquired using a color camera sensor.

4. The computer-implemented method of claim 1, wherein the movement information comprises rotational velocity of a rotation of the 3D coordinate measurement device about an axis of rotation.

5. The computer-implemented method of claim 1, wherein the movement information comprises an angle of an orientation of an axis of rotation relative to gravity.

6. The computer-implemented method of claim 1, wherein the movement information comprises a distance of an entrance pupil of a color camera sensor of the 3D coordinate measurement device to an axis of rotation.

7. The computer-implemented method of claim 1, wherein the movement information comprises an angle between an optical axis of a color camera sensor of the 3D coordinate measurement device and an axis of rotation.

8. The computer-implemented method of claim 1, wherein the depth information is measured based at least in part on a speed of light in air using a time-of-flight method.

9. The computer-implemented method of claim 1, wherein the depth information is estimated using photogrammetry.

10. The computer-implemented method of claim 1, wherein the operation is selected from a group consisting of feature detection, tracking, and loop closure.

11. The computer-implemented method of claim 1, wherein the moving comprises the 3D coordinate measurement device rotating about an axis of rotation.

12. The computer-implemented method of claim 1, wherein the sharpening comprises applying machine learning to the image.

13. The computer-implemented method of claim 1, wherein the sharpening comprises applying deconvolution to the image.

14. The computer-implemented method of claim 1, further comprising displaying, on a display, the sharpened image.

15. A computer-implemented method for generating a higher-resolution panoramic image from a plurality of lower-resolution images acquired during movement of a three-dimensional (3D) coordinate measurement device, the method comprising:
receiving the plurality of lower-resolution images from the 3D coordinate measurement device, wherein the image was acquired while the 3D coordinate measurement device was moving, wherein each of the plurality of lower-resolution images overlaps at least a portion of at least one other image of the plurality of images;
generating, based at least in part on movement information about the movement of the 3D coordinate measurement device, the higher-resolution panoramic image using the plurality of lower-resolution images from the 3D coordinate measurement device; and
performing, using the higher-resolution panoramic, a scanning operation.

16. The computer-implemented method of claim 15, wherein receiving the plurality of lower-resolution images from the 3D coordinate measurement device comprises acquiring, by the 3D coordinate measurement device, the plurality of lower-resolution images.

17. The computer-implemented method of claim 16, wherein the plurality of lower-resolution images are acquired using a color camera sensor.

18. The computer-implemented method of claim 15, wherein the movement information comprises rotational velocity of a rotation of the 3D coordinate measurement device about an axis of rotation.

19. The computer-implemented method of claim 15, wherein the movement information comprises an angle of an orientation of an axis of rotation relative to gravity.

20. The computer-implemented method of claim 15, wherein the movement information comprises at least one of:
(i) a distance of an entrance pupil of a color camera sensor of the 3D coordinate measurement device to an axis of rotation and
(ii) an angle between an optical axis of a color camera sensor of the 3D coordinate measurement device and an axis of rotation.
